(19) United States
(12) Patent Application Publication
(10) Pub. No.: US 2023/0265690 A1
(43) Pub. Date: Aug. 24, 2023

(54) VEHICLE LOWER STRIKER STRUCTURE

(71) Applicant: AISIN CORPORATION, Kariya (JP)

(72) Inventors: Daiki KATO, Kariya-shi (JP); Toshitsugu ODA, Kariya-shi (JP); Natsumi ONODERA, Kariya-shi (JP); Yoshihiro YAMAGUCHI, Kariya-shi (JP); Shinsuke TAKAYANAGI, Kariya-shi (JP)

(73) Assignee: AISIN CORPORATION, Kariya (JP)

(21) Appl. No.: 18/154,093

(22) Filed: Jan. 13, 2023

(30) Foreign Application Priority Data
Feb. 21, 2022 (JP) 2022-024893

(51) Int. Cl. E05B 85/04; E05B 81/16

(52) U.S. Cl. CPC E05B 85/04; E05B 81/16

(57) ABSTRACT

A vehicle lower striker structure is disposed below a door opening portion opened and closed by a vehicle door. The vehicle lower striker structure includes: a base plate that has a plate shape whose plate thickness direction is an upper-lower direction, the base plate having a slit extending in a direction intersecting with the plate thickness direction; and a striker shaft that has a rod shape whose longitudinal direction is a direction intersecting the upper-lower direction, the striker shaft being fixed to the base plate and straddling the slit.

### CROSS REFERENCE TO RELATED APPLICATIONS

This application is based on and claims priority under 35 U.S.C. §119 to Japanese Patent Application 2022-024893, filed on Feb. 21, 2022, the entire content of which is incorporated herein by reference.

### TECHNICAL FIELD

This disclosure relates to a vehicle lower striker structure.

### BACKGROUND DISCUSSION

JP 2005-88812A (Reference 1) discloses a vehicle including a vehicle body having a door opening portion formed in a side portion thereof, and a front slide door and a rear slide door that open and close the door opening portion. The front slide door opens the front half of the door opening portion by sliding forward. The rear slide door opens the rear half of the door opening portion by sliding rearward.

As described above, since a vehicle including a double opening type slide door does not include a center pillar, a striker cannot be disposed in a center pillar. Therefore, in order to restrain the slide door at a fully-closed position, it is necessary to dispose a striker on a floor of the vehicle body and dispose a door lock device that locks to the striker at a lower end portion of the slide door. However, such a striker is preferably low in height in an upper-lower direction when being disposed on the floor of the vehicle body.

### SUMMARY

According to an aspect of this disclosure, a vehicle lower striker structure is disposed below a door opening portion opened and closed by a vehicle door. The vehicle lower striker structure includes: a base plate that has a plate shape whose plate thickness direction is an upper-lower direction, the base plate having a slit extending in a direction intersecting with the plate thickness direction; and a striker shaft that has a rod shape whose longitudinal direction is a direction intersecting the upper-lower direction, the striker shaft being fixed to the base plate and straddling the slit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a vehicle including a lower striker structure;

FIG. 2 is a perspective view of the lower striker structure and a lower lock device;

FIG. 3 is a perspective view of the lower striker structure;

FIG. 4 is an exploded perspective view of the lower striker structure;

FIG. 5 is a cross-sectional view of the lower striker structure;

FIG. 6 is a front view of the lower lock device;

FIG. 7 is a rear view of the lower lock device;

FIG. 8 is a front view showing the lower lock device and the lower striker structure in a released state;

FIG. 9 is a front view showing the lower lock device and the lower striker structure in the middle of transition from the released state to a locked state; and

FIG. 10 is a front view showing the lower lock device and the lower striker structure in the locked state.

### DETAILED DESCRIPTION

Hereinafter, an embodiment of a vehicle including a vehicle lower striker structure (hereinafter, also referred to as a “lower striker structure”) will be described. In the drawings, an X axis is an axis extending in a vehicle front-rear direction, a Y axis is an axis extending in a vehicle width direction, and a Z axis is an axis extending in a vehicle upper-lower direction. In the following description, the vehicle front-rear direction is also referred to as a front-rear direction, the vehicle width direction is also referred to as a width direction, and the vehicle upper-lower direction is also referred to as an upper-lower direction.

### Vehicle 10

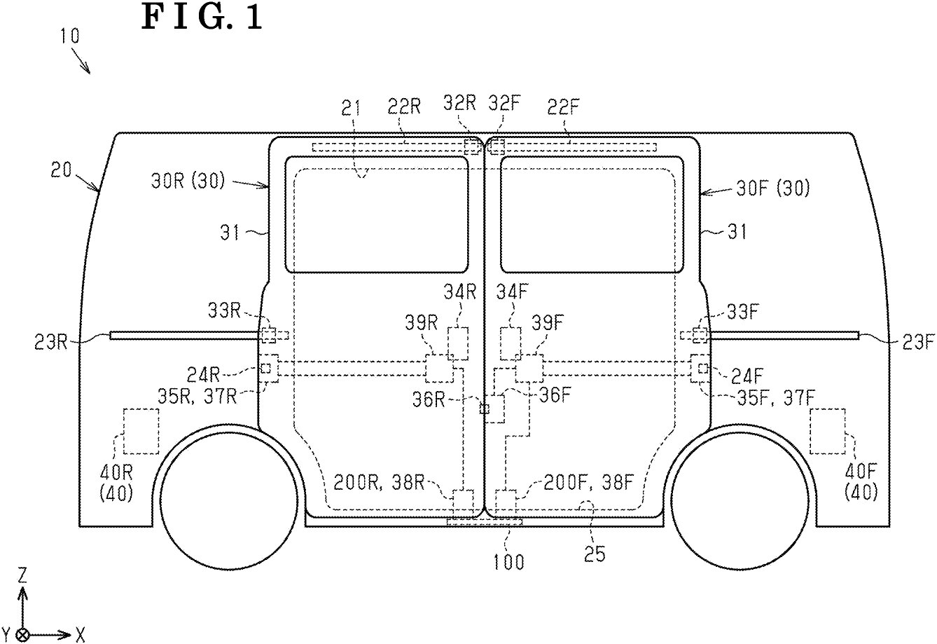

As shown in FIG. 1, a vehicle 10 includes a vehicle body 20, a slide door 30, and a door drive unit 40.

### Vehicle Body 20

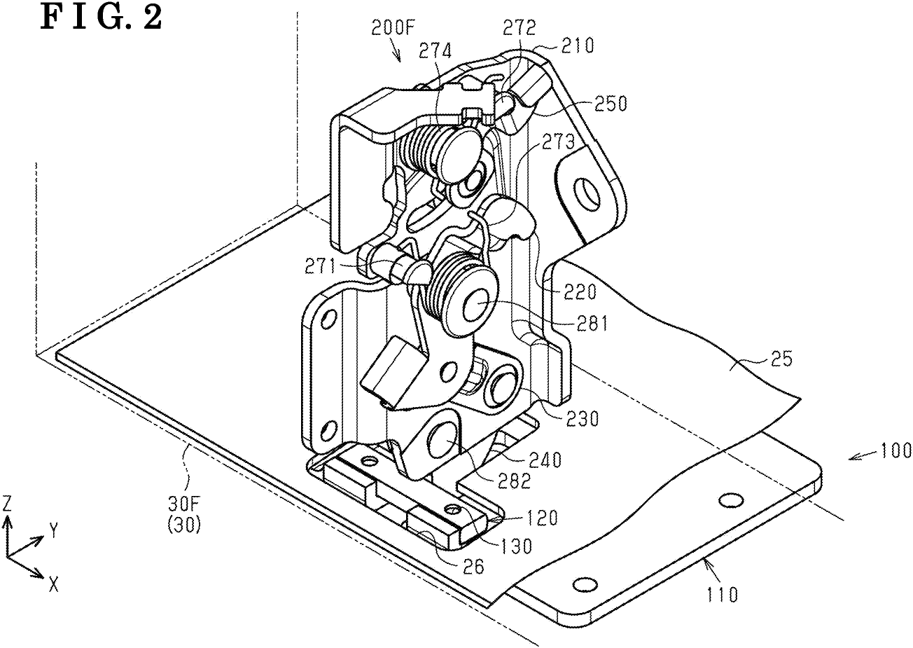

As shown in FIG. 1, the vehicle body 20 has a door opening portion 21, upper rails 22F and 22R, center rails 23F and 23R, a front striker 24F, and a rear striker 24R. As shown in FIGS. 1 and 2, the vehicle body 20 has a lower striker structure 100 and a floor panel 25.

The upper rails 22F and 22R are disposed above the door opening portion 21, and the center rails 23F and 23R are disposed below the upper rails 22F and 22R. The upper rail 22F is disposed in front of a center of the door opening portion 21 in the front-rear direction, and the center rail 23F is disposed in front of the door opening portion 21. The upper rail 22R is disposed behind the center of the door opening portion 21 in the front-rear direction, and the center rail 23R is disposed behind the door opening portion 21. A longitudinal direction of the upper rails 22F and 22R and the center rails 23F and 23R is mainly the front-rear direction.

The front striker 24F is disposed in front of the door opening portion 21. The rear striker 24R is disposed behind the door opening portion 21. The lower striker structure 100 is disposed below the door opening portion 21. The lower striker structure 100 will be described in detail later.

As shown in FIG. 2, the floor panel 25 has a plate shape. The floor panel 25 constitutes a bottom portion of the interior of the vehicle 10. The floor panel 25 has a through hole 26 through which the lower striker structure 100 is exposed upward. Although not shown in FIGS. 1 and 2, two through holes 26 are opened in the floor panel 25 and are spaced apart from each other in the front-rear direction. Each through hole 26 has a T shape in a plan view in the upper-lower direction.

### Slide Door 30

As shown in FIG. 1, the slide door 30 includes a front door 30F for opening and closing a front half range of the door opening portion 21, and a rear door 30R for opening and closing a rear half range of the door opening portion 21.

The front door 30F is opened by being moved forward, and closed by being moved rearward. Meanwhile, the rear door 30R is opened by being moved rearward, and closed by being moved forward. That is, the front door 30F and the rear door 30R are opened by being moved away from each other, and closed by being moved toward each other. Thus, the front door 30F and the rear door 30R are opened and closed between a “fully-opened position” where the door opening portion 21 is fully opened and a “fully-closed position” where the door opening portion 21 is fully closed. The front door 30F and the rear door 30R correspond to a “vehicle door”.

### Front Door 30F

As shown in FIG. 1, the front door 30F includes a door main body 31, an upper guide unit 32F, a center guide unit 33F, and a door handle 34F. The front door 30F includes a front lock device 35F, a center lock device 36F, a lower lock device 200F, a front lock drive device 37F, a lower lock drive device 38F, and a remote controller 39F.

The door main body 31 has a rectangular shape corresponding to a front half shape of the door opening portion 21 in a side view. The door main body 31 includes an inner panel and an outer panel that are spaced apart from each other in the width direction. Some of components of the front door 30F are accommodated in a space between the inner panel and the outer panel. Although not shown, a seal member having elasticity is attached to a surface of the door main body 31 that faces inward in the vehicle width direction along an outer edge of the door main body 31. The seal member is compressed between the front door 30F positioned at the fully-closed position and the door opening portion 21. Thus, the seal member prevents rain from entering the interior of the vehicle 10 from between the front door 30F and the door opening portion 21.

The upper guide unit 32F is fixed to an upper rear end portion of the door main body 31. The upper guide unit 32F is engaged with the upper rail 22F so as to be movable in the longitudinal direction of the upper rail 22F. The center guide unit 33F is fixed to a front end portion of the door main body 31 at a center portion of the door main body 31 in the upper-lower direction. The center guide unit 33F is engaged with the center rail 23F so as to be movable in the longitudinal direction of the center rail 23F. When the upper guide unit 32F and the center guide unit 33F are moved along the upper rail 22F and the center rail 23F, respectively, the front door 30F can be moved in the front-rear direction with respect to the vehicle body 20.

The door handle 34F is an inside door handle provided on a surface of the door main body 31 facing the inside of the vehicle 10. The door handle 34F may be an outside door handle provided on a surface of the door main body 31 facing the outside of the vehicle 10.

The front lock device 35F is provided at a front end portion of the door main body 31 at a center portion of the door main body 31 in the upper-lower direction. The front lock device 35F is configured to be switchable between a locked state where the front lock device 35F is locked to the front striker 24F and a released state where the front lock device 35F is not locked to the front striker 24F. When switched to the locked state, the front lock device 35F restrains a front end portion of the front door 30F positioned at the fully-closed position to the vehicle body 20. Meanwhile, when switched to the released state, the front lock device 35F releases the restraint of the front door 30F positioned at the fully-closed position.

The center lock device 36F is provided at a rear end portion of the door main body 31 at the center portion of the door main body 31 in the upper-lower direction. The center lock device 36F is configured to be switchable between a locked state where the center lock device 36F is locked to a center striker 36R of the rear door 30R and a released state where the center lock device 36F is not locked to the center striker 36R, which will be described later. When switched to the locked state, the center lock device 36F couples a rear end portion of the front door 30F and a front end portion of the rear door 30R that are positioned at the fully-closed position. Meanwhile, when the center lock device 36F is switched to the released state, the center lock device 36F releases the coupling between the front door 30F and the rear door 30R that are positioned at the fully-closed position.

The lower lock device 200F is provided at a lower rear end portion of the door main body 31. The lower lock device 200F is configured to be switchable between a locked state where the lower lock device 200F is locked to the lower striker structure 100 and a released state where the lower lock device 200F is not locked to the lower striker structure 100. When the lower lock device 200F is switched to the locked state, the lower lock device 200F restrains a lower end portion of the front door 30F positioned at the fully-closed position onto the vehicle body 20. Meanwhile, when the lower lock device 200F is switched to the released state, the lower lock device 200F releases the restraint of the front door 30F positioned at the fully-closed position. The lower lock device 200F will be described in detail later.

The front lock drive device 37F shifts the front lock device 35F from the released state to the locked state, or shifts the front lock device 35F from the locked state to the released state. The front lock drive device 37F shifts the front lock device 35F from the released state to the locked state after the front door 30F is closed to a substantially fully-closed position in the vicinity of the fully-closed position. Meanwhile, the front lock drive device 37F shifts the front lock device 35F from the locked state to the released state when opening the front door 30F from the fully-closed position.

The lower lock drive device 38F shifts the lower lock device 200F from the released state to the locked state. The lower lock drive device 38F shifts the lower lock device 200F to the locked state after the front lock drive device 37F shifts the front lock device 35F to the locked state, that is, after the front door 30F is closed to the fully-closed position.

The remote controller 39F relays power transmitted among the door handle 34F, the front lock drive device 37F, the center lock device 36F, and the lower lock device 200F. Specifically, when the front lock drive device 37F is to shift the front lock device 35F to the released state, the remote controller 39F transmits the power to the center lock device 36F and the lower lock device 200F. Then, the remote controller 39F shifts the center lock device 36F and the lower lock device 200F from the locked state to the released state. When a user operates the door handle 34F, the remote controller 39F transmits the power to the front lock device 35F, the center lock device 36F, and the lower lock device 200F. Then, the remote controller 39F shifts the front lock device 35F, the center lock device 36F, and the lower lock device 200F from the locked state to the released state.

### Rear Door 30R

As shown in FIG. 1, the rear door 30R includes the door main body 31, an upper guide unit 32R, a center guide unit 33R, and a door handle 34R. The rear door 30R includes a rear lock device 35R, a center striker 36R, a rear lock drive device 37R, a lower lock device 200R, a lower lock drive device 38R, and a remote controller 39R.

The rear door 30R is configured in substantially the same manner as the front door 30F. A difference from the front door 30F is that the rear lock device 35R and the rear lock drive device 37R are provided instead of the front lock device 35F and the front lock drive device 37F, and the center striker 36R is provided instead of the center lock device 36F. Therefore, a description of the configuration of the rear door 30R except for the center striker 36R will be omitted.

The center striker 36R is disposed at a front end portion of the rear door 30R at a center portion of the rear door 30R in the upper-lower direction. In other words, the center striker 36R is disposed at a position facing the center lock device 36F of the front door 30F in the front-rear direction. The center striker 36R is an object to be locked by the center lock device 36F.

### Door Drive Unit 40

As shown in FIG. 1, the door drive unit 40 includes a first door drive unit 40F that drives the front door 30F in an opening-closing direction, and a second door drive unit 40R that drives the rear door 30R in the opening-closing direction. The first door drive unit 40F and the second door drive unit 40R each include, for example, a motor and a transmission mechanism that transmits power of the motor to the slide door 30. The transmission mechanism of the first door drive unit 40F and the second door drive unit 40R may include a pulley and a belt, or may include a drum and a cable. The first door drive unit 40F and the second door drive unit 40R may be incorporated in the slide door 30. The front door 30F and the rear door 30R can be said to be so-called power slide doors considering that they are opened and closed by the first door drive unit 40F and the second door drive unit 40R, respectively.

### Lower Striker Structure 100

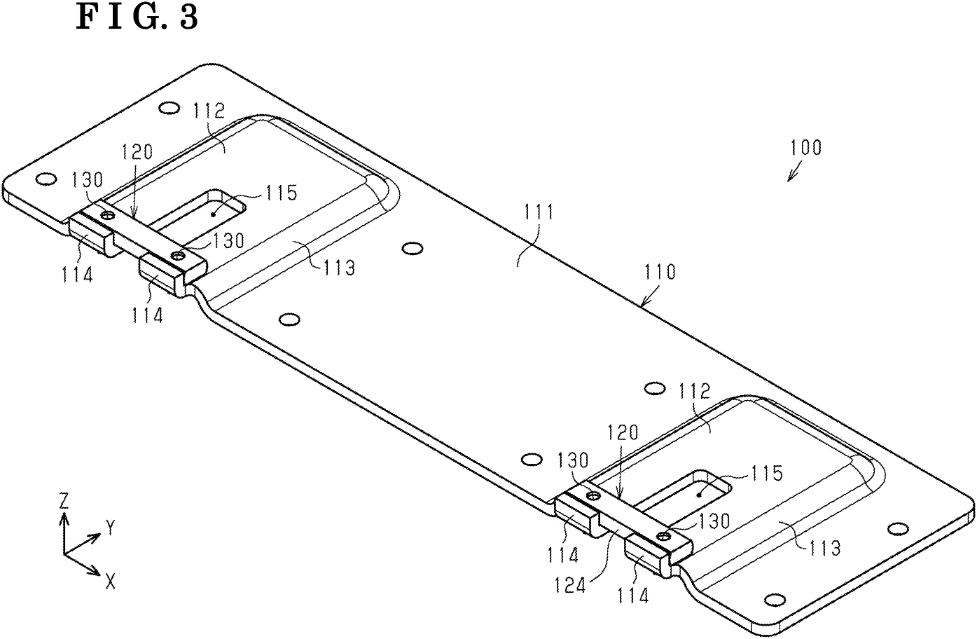

As shown in FIGS. 3 to 5, the lower striker structure 100 includes a base plate 110, two striker shafts 120, and a plurality of fastening members 130. As shown in FIG. 3, the lower striker structure 100 is symmetrical with respect to the front-rear direction. Therefore, in the following description, the front half of the lower striker structure 100 will be mainly described.

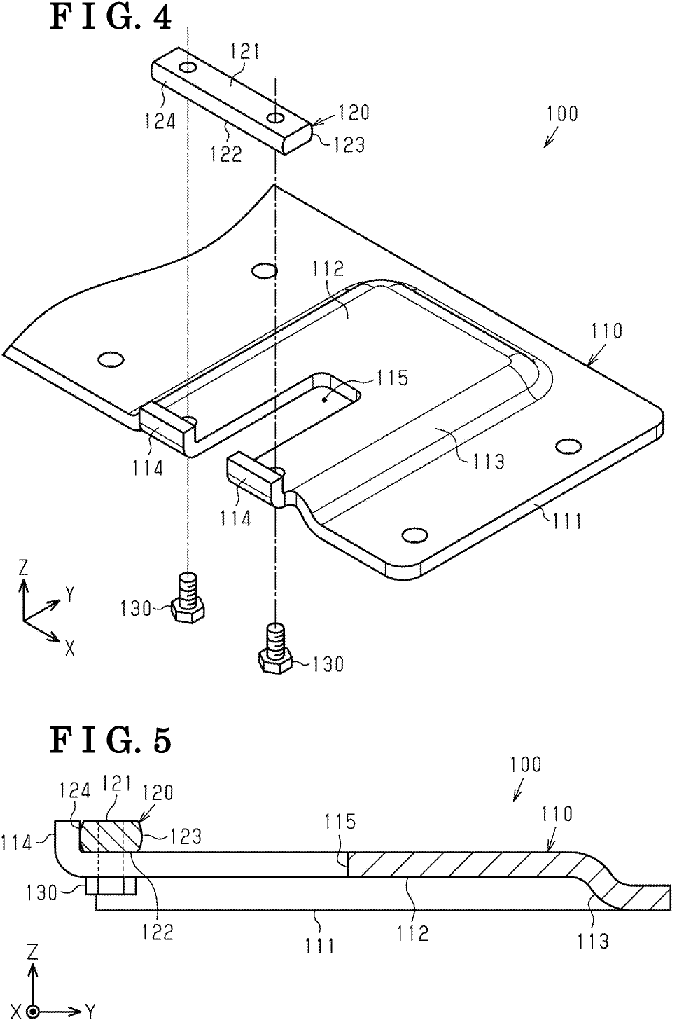

As shown in FIGS. 3 and 4, the base plate 110 has a rectangular plate shape. The base plate 110 is formed by, for example, pressing a metal plate. The base plate 110 has a first portion 111 that occupies most of the base plate 110. A front portion of the base plate 110 has a second portion 112 positioned above the first portion 111, a coupling portion 113 coupling the first portion 111 and the second portion 112, and two bent portions 114 extending from the second portion 112.

The first portion 111 has a flat plate shape. The first portion 111 is, for example, a portion fixed to a frame structure, a monocoque structure, or the like of the vehicle body 20. In addition, the first portion 111 is also a portion to which the floor panel 25 is fixed.

The second portion 112 has a flat plate shape. The second portion 112 has a rectangular shape in a plan view in the upper-lower direction. An outer end portion of the second portion 112 in the width direction is flush with an outer end portion of the first portion 111 in the width direction. Meanwhile, an inner end portion of the second portion 112 in the width direction is positioned outward of an inner end portion of the first portion 111 in the width direction. The second portion 112 has a slit 115 extending in the width direction. The slit 115 extends from an end portion of the second portion 112 toward a center portion of the second portion 112 in the width direction. The slit 115 has a rectangular shape with the front-rear direction as a lateral direction and the width direction as a longitudinal direction in a plan view in the upper-lower direction. That is, the width direction of the slit 115 is the front-rear direction of the vehicle 10.

The coupling portion 113 is a boundary portion between the first portion 111 and the second portion 112. The coupling portion 113 bends and couples the first portion 111 and the second portion 112, which are shifted from each other in the upper-lower direction. Therefore, a plate thickness direction of the coupling portion 113 is inclined with respect to a plate thickness direction of the first portion 111 and a plate thickness direction of the second portion 112.

The two bent portions 114 are bent from the second portion 112 in a state of being spaced apart from each other in the front-rear direction. Specifically, the two bent portions 114 slightly extend outward in the width direction and then extend upward on both sides of the slit 115. Therefore, when the two bent portions 114 are viewed in the front-rear direction, the two bent portions 114 are L-shaped. A length of the two bent portions 114 in the width direction is shorter than a length of the two bent portions 114 in the upper-lower direction.

As shown in FIGS. 4 and 5, the striker shaft 120 has a rod shape whose axial direction is the front-rear direction. A length of the striker shaft 120 in the axial direction is longer than a width of the slit 115 of the base plate 110. As shown in FIG. 5, a shape of a cross section orthogonal to the axial direction of the striker shaft 120 is an oval shape. That is, an upper surface 121 and a bottom surface 122 of the striker shaft 120, which intersect with the upper-lower direction, are flat surfaces. An inner side surface 123 and an outer side surface 124 of the striker shaft 120, which intersect with the width direction, are curved surfaces. Specifically, when the striker shaft 120 is viewed from the longitudinal direction, the inner side surface 123 and the outer side surface 124 form an arc shape that protrudes outward. In the present embodiment, a length from the bottom surface 122 to the upper surface 121 of the striker shaft 120 is approximately the same as a height of the bent portions 114 with reference to an upper surface of the second portion 112 of the base plate 110.

As shown in FIGS. 3 to 5, the striker shaft 120 is fixed to the base plate 110 and straddles the slit 115 of the base plate 110. Specifically, the striker shaft 120 is fixed to the second portion 112 of the base plate 110 by two fastening members 130. At this time, the striker shaft 120 is positioned above the second portion 112 of the base plate 110. The fastening members 130 fasten the striker shaft 120 to the second portion 112 of the base plate 110 from below the second portion 112 of the base plate 110.

In this respect, the bottom surface 122 of the striker shaft 120 is in contact with the base plate 110. That is, the striker shaft 120 is in contact with the second portion 112 of the base plate 110 from above. The outer side surface 124 of the striker shaft 120 is in contact with the two bent portions 114 of the base plate 110. That is, the striker shaft 120 is in contact with the two bent portions 114 of the base plate 110 from the inner side in the width direction.

As shown in FIG. 3, in the lower striker structure 100, the striker shaft 120 on the front side is an object to be locked by the lower lock device 200F of the front door 30F, and the striker shaft 120 on the rear side is an object to be locked by the lower lock device 200R of the rear door 30R. In this respect, in the lower striker structure 100 according to the present embodiment, the objects to be locked by both the lower lock device 200F of the front door 30F and the lower lock device 200R of the rear door 30R are provided on one base plate 110.

### Lower Lock Devices 200F and 200R

Hereinafter, the lower lock devices 200F and 200R will be described in detail. The lower lock device 200F of the front door 30F and the lower lock device 200R of the rear door 30R are symmetrical with respect to the front-rear direction. Therefore, in the following description, the lower lock device 200F of the front door 30F will be described.

As shown in FIGS. 2, 6, and 7, the lower lock device 200F includes a base frame 210, a drive lever 220, a relay link 230, a hook 240, a release lever 250, and a pawl 260. The lower lock device 200F includes a plurality of stoppers 271 and 272, a plurality of springs 273 and 274, a plurality of support shafts 281 to 284, and a plurality of coupling shafts 285 to 287.

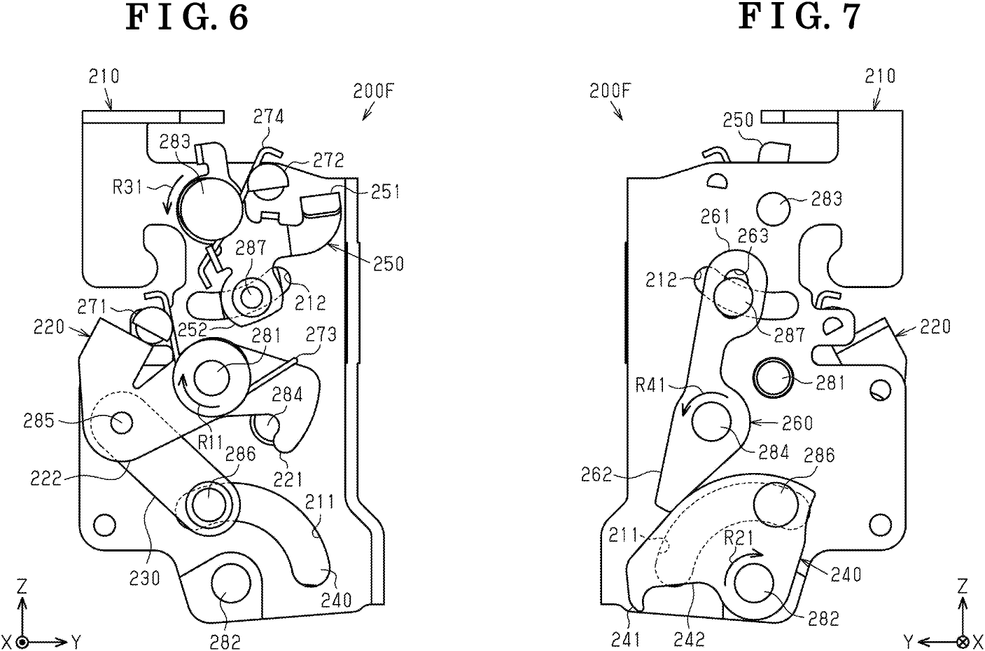

The base frame 210 has a plate shape. The base frame 210 can be formed by, for example, pressing a metal plate. The base frame 210 has a first guide groove 211 that guides rotation of the hook 240 and a second guide groove 212 that guides rotation of the release lever 250. The first guide groove 211 has an arc shape centered on an axis of the second support shaft 282, and the second guide groove 212 has an arc shape centered on an axis of the third support shaft 283. A width of the first guide groove 211 is larger than an outer diameter of the second coupling shaft 286, and a width of the second guide groove 212 is larger than an outer diameter of the third coupling shaft 287. The first stopper 271 that limits an operation range of the drive lever 220 and the second stopper 272 that limits an operation range of the release lever 250 are fixed to the base frame 210. The base frame 210 is fixed to the door main body 31 of the front door 30F by fastening members such as bolts. In the following description, one surface of the base frame 210 in the plate thickness direction, which is shown in FIG. 6, is referred to as a front surface, and the other surface of the base frame 210 in the plate thickness direction, which is shown in FIG. 7, is referred to as a rear surface.

As shown in FIG. 6, the drive lever 220 includes a first lever 221 and a second lever 222 extending in different directions. The drive lever 220 is supported on a front surface side of the base frame 210 at a center portion of the base frame 210 by the first support shaft 281 whose axial direction is the front-rear direction. Thus, the drive lever 220 is rotatable about an axis of the first support shaft 281. The drive lever 220 is biased in a first rotation direction R11 by the first spring 273. In the present embodiment, the first spring 273 is a torsion coil spring, and may be a spring of any other type as long as the spring can bias the drive lever 220 in the first rotation direction R11. In a state shown in FIG. 6, the drive lever 220 is positioned by coming into contact with the first stopper 271 of the base frame 210.

As shown in FIG. 6, the relay link 230 is a link that transmits power from the drive lever 220 to the hook 240. A first end of the relay link 230 in the longitudinal direction is coupled to the second lever 222 of the drive lever 220 by the first coupling shaft 285 whose axial direction is the front-rear direction. Thus, the relay link 230 and the drive lever 220 are rotatable relative to each other about an axis of the first coupling shaft 285. Meanwhile, a second end of the relay link 230 in the longitudinal direction is coupled to the hook 240 by the second coupling shaft 286 whose axial direction is the front-rear direction. Thus, the relay link 230 and the hook 240 are rotatable relative to each other about an axis of the second coupling shaft 286.

As shown in FIG. 7, the hook 240 has a protruding locking claw 241 and a locking recess 242 coupled to the locking claw 241. The hook 240 is supported on a rear surface side of the base frame 210 at a lower end portion of the base frame 210 by the second support shaft 282 whose axial direction is the front-rear direction. Thus, the hook 240 is rotatable about the axis of the second support shaft 282 with respect to the base frame 210. The locking claw 241 and the locking recess 242 of the hook 240 are portions that are locked to the lower striker structure 100 in the lower lock device 200F. Therefore, it is preferable that shapes of the locking claw 241 and the locking recess 242 are shapes corresponding to the striker shaft 120 of the lower striker structure 100 which is an object to be locked by the hook 240.

In the present embodiment, the base frame 210, the drive lever 220, the relay link 230, and the hook 240 constitute a so-called four-section link mechanism. That is, the drive lever 220, the relay link 230, and the hook 240 are interlocked with each other. Therefore, it can be said that the hook 240 is biased in a first rotation direction R21 considering that the drive lever 220 is biased in the first rotation direction R11. As a result, in the state shown in FIGS. 6 and 7, the hook 240 is positioned at a retracted position.

In the present embodiment, the second coupling shaft 286 that couples the relay link 230 and the hook 240 passes through the first guide groove 211 of the base frame 210. In this respect, when the relay link 230 operates, the second coupling shaft 286 moves along the first guide groove 211 of the base frame 210.

As shown in FIG. 6, the release lever 250 includes a third lever 251 and a fourth lever 252 extending in different directions. The release lever 250 is supported on the front surface side of the base frame 210 at an upper portion of the base frame 210 by the third support shaft 283 whose axial direction is the front-rear direction. Thus, the release lever 250 is rotatable about the axis of the third support shaft 283 with respect to the base frame 210. The release lever 250 is biased in a first rotation direction R31 by the second spring 274. In the present embodiment, the second spring 274 is a torsion coil spring, and may be a spring of any other type as long as the spring can bias the release lever 250 in the first rotation direction R31.

As shown in FIG. 7, the pawl 260 has a rod shape. The pawl 260 has a base end portion 261 forming one end portion in the longitudinal direction and a front end portion 262 forming the other end portion in the longitudinal direction. The base end portion 261 is provided with an elongated hole 263 having an oval shape in a plan view. The front end portion 262 is tapered toward the front end. The pawl 260 is supported on the rear surface side of the base frame 210 at the center portion of the base frame 210 by the fourth support shaft 284 whose axial direction is the front-rear direction. At this time, the fourth support shaft 284 passes through a portion between the base end portion 261 and the front end portion 262 of the pawl 260. Thus, the pawl 260 is rotatable about the axis of the fourth support shaft 284 with respect to the base frame 210. The base end portion 261 of the pawl 260 is coupled to the fourth lever 252 of the release lever 250 by the third coupling shaft 287 whose axial direction is the front-rear direction. At this time, the third coupling shaft 287 is inserted through the elongated hole 263 of the pawl 260. Thus, the pawl 260 is relatively displaceable with respect to the release lever 250.

Here, the third coupling shaft 287 that couples the pawl 260 and the release lever 250 passes through the second guide groove 212 of the base frame 210. In this respect, when the pawl 260 operates, the third coupling shaft 287 moves along the second guide groove 212 of the base frame 210.

In the present embodiment, the base frame 210, the release lever 250, and the pawl 260 having the elongated hole 263 constitute a so-called four-section slider crank mechanism. That is, the release lever 250 and the pawl 260 are interlocked with each other. Therefore, it can be said that the pawl 260 is biased in a first rotation direction R41 considering that the release lever 250 is biased in the first rotation direction R31. However, the rotation of the pawl 260 in the first rotation direction R41 is limited by the contact with the hook 240.

### Operation of Present Embodiment

An operation of closing the slide door 30 will be described with reference to FIGS. 1 and 8 to 10.

As shown in FIG. 1, when the slide door 30 is to be closed, the front door 30F is closed to a substantially fully-closed position by the first door drive unit 40F, and the rear door 30R is closed to a substantially fully-closed position by the second door drive unit 40R. The substantially fully-closed position is a position slightly shifted from the fully-closed position in an opening direction.

When the front door 30F and the rear door 30R reach the substantially fully-closed position, the rear lock device 35R is shifted to the locked state by the rear lock drive device 37R. That is, the rear door 30R is closed from the substantially fully-closed position to the fully-closed position. When the shift of the rear lock device 35R to the locked state is completed, the front lock device 35F is shifted to the locked state by the front lock drive device 37F. That is, the front door 30F is closed from the substantially fully-closed position to the fully-closed position.

When the front door 30F is to be closed to the fully-closed position while the rear door 30R is positioned at the fully-closed position, the rear end portion of the front door 30F approaches the front end portion of the rear door 30R. In other words, the center lock device 36F of the front door 30F approaches the center striker 36R of the rear door 30R. As a result, the center lock device 36F is shifted to the locked state.

When the front lock device 35F, the rear lock device 35R, and the center lock device 36F are shifted to the locked state, the lower lock drive devices 38F and 38R are driven to shift the lower lock devices 200F and 200R to the locked state. Hereinafter, an operation of the lower lock device 200F when the lower lock device 200F shifts to the locked state will be described in detail. Since an operation of the lower lock device 200R is substantially the same as the operation of the lower lock device 200F, the description thereof will be omitted.

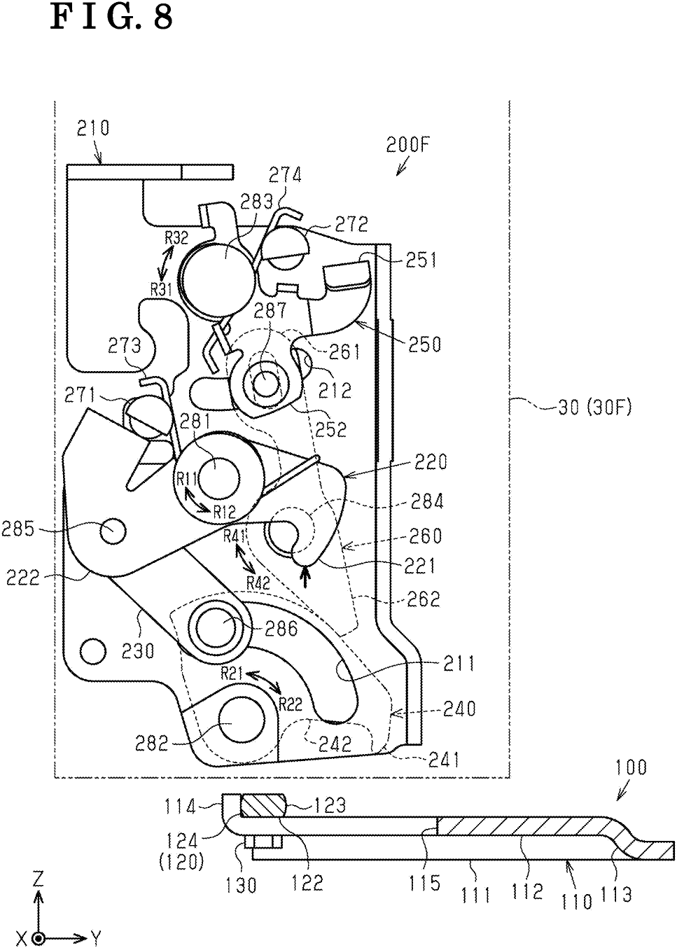

FIG. 8 shows a positional relationship between the lower lock device 200F and the lower striker structure 100 when the front lock device 35F, the rear lock device 35R, and the center lock device 36F are shifted to the locked state. As shown in FIG. 8, before the lower lock device 200F shifts to the locked state, the lower end portion of the front door 30F is positioned outward with respect to the vehicle body 20 in the width direction. The position of the front door 30F is related to a magnitude of an elastic modulus of the seal member positioned between the door opening portion 21 and the front door 30F, a position of the center of gravity of the front door 30F, a support mode of the front door 30F, or the like.

When the lower lock device 200F is to be shifted to the locked state, the lower lock drive device 38F transmits a load indicated by a solid arrow in FIG. 8 to the drive lever 220. Then, the drive lever 220 rotates in a second rotation direction R12, so that the relay link 230 and the hook 240 operate. As a result, the hook 240 rotates in a second rotation direction R22. When the hook 240 rotates, the front end portion 262 of the pawl 260 slides on a rear surface of the hook 240.

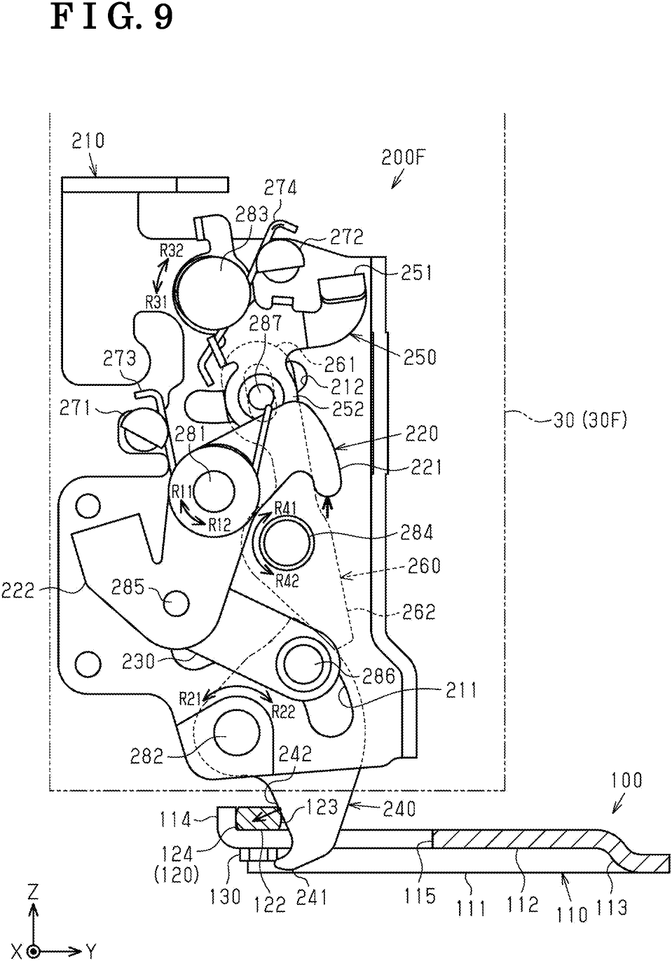

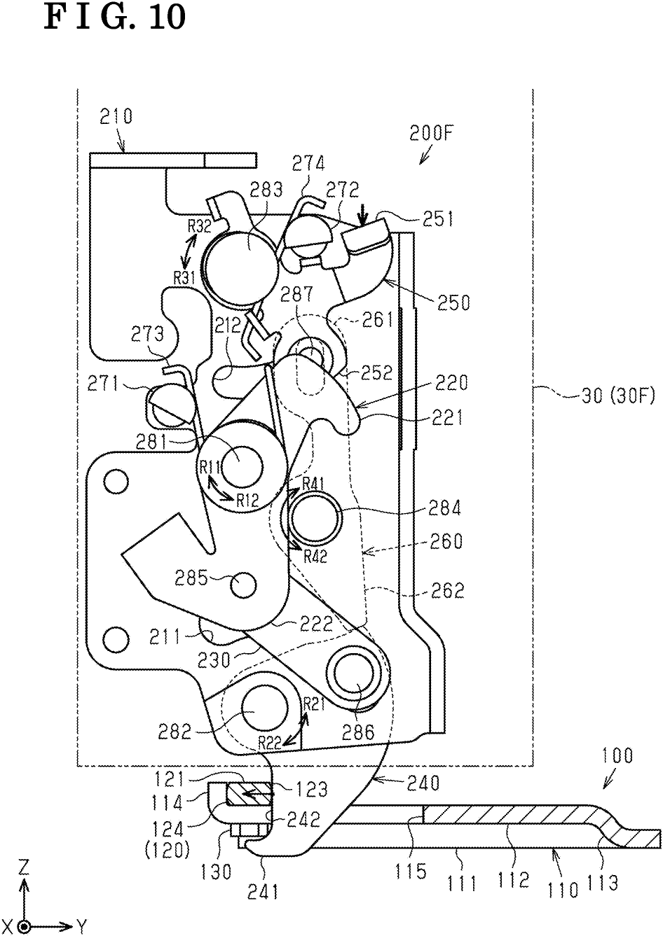

As shown in FIG. 9, when the rotation of the drive lever 220 in the second rotation direction R12 is continued by the lower lock drive device 38F, the locking recess 242 of the hook 240 comes into contact with the inner side surface 123 of the striker shaft 120. When the rotation of the hook 240 in the second rotation direction R22 is continued even after the hook 240 comes into contact with the striker shaft 120, the locking recess 242 of the hook 240 and the inner side surface 123 of the striker shaft 120 slide. Here, since the inner side surface 123 of the striker shaft 120 is a curved surface, a sliding resistance between the hook 240 and the striker shaft 120 tends to be small.

When the hook 240 slides on the striker shaft 120, the hook 240 pushes the striker shaft 120 in a direction indicated by a solid arrow in FIG. 9. As indicated by the solid arrow in FIG. 9, at the beginning of the contact of the hook 240 with the striker shaft 120, the direction in which the hook 240 pushes the striker shaft 120 is a direction formed by an outward direction in the width direction and a downward direction. In other words, a load acting on the striker shaft 120 includes an outward component in the width direction and a downward component.

As shown in FIGS. 9 and 10, when the rotation of the drive lever 220 in the second rotation direction R22 is continued even after the hook 240 comes into contact with the striker shaft 120, a state in which the hook 240 pushes the striker shaft 120 outward in the width direction continues. Here, although the lower striker structure 100 including the striker shaft 120 is not displaceable with respect to the vehicle body 20, the lower end portion of the front door 30F is slightly displaceable in the width direction. Therefore, due to a reaction force acting on the hook 240, the lower lock device 200F is displaced inward in the width direction with respect to the striker shaft 120. That is, the lower end portion of the front door 30F is displaced inward in the width direction with respect to the striker shaft 120.

As shown in FIG. 10, when the hook 240 is completely locked to the striker shaft 120, the shift of the lower lock device 200F to the locked state is completed. At this time, the striker shaft 120 is completely accommodated in the locking recess 242 of the hook 240. The position of the hook 240 shown in FIG. 10 is referred to as a locked position. When the shift of the lower lock device 200F to the locked state is completed, the drive of the lower lock drive device 38F is stopped.

When the hook 240 rotates to the locked position, the front end portion 262 of the pawl 260 does not slide on the rear surface of the hook 240. Therefore, the pawl 260 rotates in the first rotation direction R41 in accordance with a biasing force of the second spring 274. When the pawl 260 is locked to the hook 240, the hook 240 cannot rotate in the first rotation direction R21. That is, the drive lever 220 cannot rotate in the first rotation direction R11 in accordance with a biasing force of the first spring 273. Therefore, even after the drive of the lower lock drive device 38F is stopped, a state in which the hook 240 is locked to the striker shaft 120 is maintained. Thus, the closing of the slide door 30 is completed.

Next, an operation of opening the slide door 30 will be described.

As shown in FIG. 1, when the slide door 30 is to be opened, the front lock drive device 37F and the rear lock drive device 37R are driven. As a result, the front lock device 35F and the rear lock device 35R are shifted to the released state. At this time, the remote controller 39F transmits power transmitted from the front lock device 35F to the center lock device 36F. As a result, the center lock device 36F is shifted to the released state. The remote controller 39F transmits the power transmitted from the front lock device 35F to the lower lock device 200F, and the remote controller 39R transmits power transmitted from the rear lock device 35R to the lower lock device 200R. Hereinafter, an operation of the lower lock device 200F when the lower lock device 200F shifts to the released state will be described in detail.

As indicated by a solid arrow in FIG. 10, power transmitted from the remote controller 39F is transmitted to the third lever 251 of the release lever 250. Then, as the release lever 250 rotates in a second rotation direction R32, the pawl 260 rotates in a second rotation direction R42. That is, when the front end portion 262 of the pawl 260 moves in a direction away from the hook 240, the front end portion 262 of the pawl 260 is not locked to the hook 240. As a result, the hook 240 rotates in the first rotation direction R21 in accordance with the biasing force of the first spring 273, and the hook 240 does not lock to the striker shaft 120. At this time, the hook 240 rotates from the locked position to the retracted position. Thus, the shift of the lower lock device 200F to the released state is completed. Similarly, the lower lock device 200F is shifted to the released state based on the power transmitted from the remote controller 39F.

Thereafter, the front door 30F is opened by the first door drive unit 40F, and the rear door 30R is opened by the second door drive unit 40R. Thus, the opening of the slide door 30 is completed.

Effects of the present embodiment will be described.

(1) The lower striker structure 100 is formed by fixing the rod-shaped striker shaft 120 to the plate-shaped base plate 110. Therefore, the lower striker structure 100 can be made thinner in the upper-lower direction than a U-shaped striker in a comparative example. Therefore, the lower striker structure 100 can prevent the striker from protruding upward from the floor panel 25, and can easily secure a space for disposing an electric slope device or the like below the floor panel 25.

(2) In order to increase rigidity of the striker shaft 120, it is conceivable to increase the thickness of the striker shaft 120, or increase the width of the striker shaft 120. However, when the thickness of the striker shaft 120 is increased, it is difficult to reduce a thickness of the lower striker structure 100 in the upper-lower direction. In this regard, the thickness of the striker shaft 120 according to the present embodiment is smaller than the width thereof. In other words, a cross-sectional area orthogonal to the longitudinal direction of the striker shaft 120 is increased by increasing the width of the striker shaft 120. Therefore, the lower striker structure 100 can easily secure the rigidity of the striker shaft 120 while reducing the thickness of the striker shaft 120 in the upper-lower direction.

(3) As shown in FIG. 9, the hook 240 of each of the lower lock devices 200F and 200R is locked to the striker shaft 120 while sliding on the side surface of the striker shaft 120. In this regard, since the side surface of the striker shaft 120 is a curved surface, when the hook 240 of each of the lower lock devices 200F and 200R is locked to the striker shaft 120, the hook 240 of each of the lower lock devices 200F and 200R can smoothly slide on the striker shaft 120.

(4) The lower striker structure 100 can be configured such that the striker shaft 120 is less likely to protrude upward because the upper surface 121 of the striker shaft 120 is a flat surface. In addition, in the lower striker structure 100, a contact area between the striker shaft 120 and the base plate 110 is easily increased because the bottom surface 122 of the striker shaft 120 is a flat surface. That is, in the lower striker structure 100, an attitude of the striker shaft 120 with respect to the base plate 110 can be stabilized.

(5) As shown in FIG. 9, when the hook 240 of each of the lower lock devices 200F and 200R is locked to the striker shaft 120, the hook 240 pushes the striker shaft 120, and a load including a downward component acts on the striker shaft 120. Therefore, in a comparative example in which the striker shaft 120 is in contact with the base plate 110 from below, when the load including the downward component acts on the striker shaft 120, the load is transmitted to the base plate 110 via the fastening member 130. Therefore, in the comparative example, a load is easily applied to the fastening member 130. In this regard, in the lower striker structure 100, since the striker shaft 120 is in contact with the base plate 110 from above, the load acting on the striker shaft 120 is transmitted to the base plate 110 without passing through the fastening member 130. Therefore, the lower striker structure 100 can reduce the load on the fastening member 130 when the load acts on the striker shaft 120.

(6) As shown in FIG. 9, when the hook 240 of each of the lower lock devices 200F and 200R is locked to the striker shaft 120, a load including a component in the width direction may be applied. In this regard, the outer side surface 124 of the striker shaft 120 is in contact with the bent portion 114 positioned in the direction in which the load acts, when viewed from the striker shaft 120. Therefore, the load acting on the striker shaft 120 is easily transmitted to the base plate 110. Therefore, the lower striker structure 100 can reduce the load on the fastening member 130 when the load acts on the striker shaft 120.

(7) In the base plate 110 of the lower striker structure 100, the second portion 112 to which the striker shaft 120 is fixed is positioned above the first portion 111. Therefore, in the lower striker structure 100, the striker shaft 120, which is an object to be locked by the hook 240 of each of the lower lock devices 200F and 200R, can be disposed on the upper side of the lower striker structure 100, and a portion of the lower striker structure 100, which is not an object to be locked by the hook 240 of each of the lower lock devices 200F and 200R, can be disposed on the lower side of the lower striker structure 100. Therefore, in the lower striker structure 100, the striker shaft 120 can be disposed in the vicinity of the slide door 30 positioned at the fully-closed position in the upper-lower direction. Therefore, the hook 240 of each of the lower lock devices 200F and 200R can be easily locked to the striker shaft 120 without increasing the size of the hook 240 of each of the lower lock devices 200F and 200R.

### Modification

The present embodiment can be modified as follows. The present embodiment and the following modifications can be implemented in combination with each other as long as the present embodiment and the modifications do not have technical contradiction.
Although the vehicle 10 includes the lower striker structure 100 having two striker shafts 120, the vehicle 10 may include two lower striker structures each having one striker shaft 120.
ln the base plate 110 of the lower striker structure 100, the first portion 111 and the second portion 112 may be positioned at the same height. In other words, the base plate 110 may have a configuration in which only the slit 115 is provided in a flat plate.
ln the lower striker structure 100, the base plate 110 may not have the bent portion 114. In this case, it is preferable that the striker shaft 120 is more firmly fixed to the base plate 110.
ln the lower striker structure 100, a mode in which the striker shaft 120 is fixed to the base plate 110 can be changed as appropriate. For example, the striker shaft 120 may be welded to the base plate 110.
ln the lower striker structure 100, the cross-sectional shape of the striker shaft 120 can be changed as appropriate. For example, the striker shaft 120 may have a cylindrical shape or a quadrangular prism shape. In addition, the cross-sectional shape of the striker shaft 120 may change in the axial direction. Further, the thickness of the striker shaft 120 in the upper-lower direction may be larger than the length of the striker shaft 120 in the width direction.
Shapes of the hooks 240 of the lower lock devices 200F and 200R can be changed as appropriate. Each of the lower lock devices 200F and 200R may include a latch employed in a general door lock device instead of the hook 240.
The vehicle 10 may be a vehicle including one of the front door 30F and the rear door 30R. In this case, the lower striker structure 100 may include one striker shaft 120.
The door opening portion 21 may be opened to a front surface and a rear surface of the vehicle body 20. In this case, in the lower striker structure 100 disposed on a lower portion of the door opening portion 21, an axial direction of the striker shaft 120 is the width direction, and an extending direction of the slit 115 is the front-rear direction. An opening-closing direction of the slide door 30 is the width direction.

Hereinafter, a method for solving the problem of the related art and functions and effects thereof will be described.

According to an aspect of this disclosure, a vehicle lower striker structure is disposed below a door opening portion opened and closed by a vehicle door. The vehicle lower striker structure includes: a base plate that has a plate shape whose plate thickness direction is an upper-lower direction, the base plate having a slit extending in a direction intersecting with the plate thickness direction; and a striker shaft that has a rod shape whose longitudinal direction is a direction intersecting the upper-lower direction, the striker shaft being fixed to the base plate and straddling the slit.

The vehicle lower striker structure is formed by fixing a rod-shaped striker shaft to the plate-shaped base plate. Therefore, the vehicle lower striker structure can be made thinner in the upper-lower direction than a U-shaped lower striker structure.

In the vehicle lower striker structure, it is preferable that the striker shaft has a rod shape extending in a straight line shape.

In the vehicle lower striker structure, it is preferable that the striker shaft has a thickness in the upper-lower direction smaller than a width of the striker shaft in an extending direction of the slit.

In order to increase rigidity of the striker shaft, it is conceivable to increase the thickness of the striker shaft in the upper-lower direction or increase the width of the striker shaft in the extending direction of the slit. However, when the thickness of the striker shaft is increased, it is difficult to reduce a thickness of the vehicle lower striker structure in the upper-lower direction. In this regard, for the striker shaft having the above-described configuration, the thickness in the upper-lower direction is smaller than the width in the extending direction of the slit. Therefore, in the vehicle lower striker structure, it is easy to secure the rigidity of the striker shaft while reducing the thickness of the striker shaft in the upper-lower direction.

In the vehicle lower striker structure, it is preferable that a side surface of the striker shaft intersecting with an extending direction of the slit has an arc shape protruding outward when viewed from the longitudinal direction of the striker shaft.

A locking portion of a door lock device may be locked to the striker shaft while sliding on the side surface of the striker shaft. In this regard, the side surface of the striker shaft has an arc shape when viewed from the longitudinal direction of the striker shaft. Therefore, when the locking portion of the door lock device is locked to the striker shaft, the locking portion of the door lock device can smoothly slide on the side surface of the striker shaft.

In the vehicle lower striker structure, it is preferable that an upper surface and a bottom surface of the striker shaft intersecting with the upper-lower direction are flat surfaces, and the striker shaft is in contact with the base plate from above.

In the vehicle lower striker structure, the striker shaft is less likely to protrude upward because the upper surface of the striker shaft is a flat surface. In addition, in the vehicle lower striker structure, a contact area between the striker shaft and the base plate is easily increased because the bottom surface of the striker shaft is a flat surface. That is, in the vehicle lower striker structure, an attitude of the striker shaft with respect to the base plate can be stabilized.

It is preferable that the vehicle lower striker structure further includes a fastening member that fixes the striker shaft to the base plate, and the striker shaft is in contact with the base plate from above.

When the locking portion of the door lock device is locked to the striker shaft, a load including a downward component may act on the striker shaft due to the locking portion pushing the striker shaft. Therefore, in a comparative example in which the striker shaft is in contact with the base plate from below, when the load including the downward component acts on the striker shaft, the load is transmitted to the base plate via the fastening member. Therefore, in the comparative example, a load is easily applied to the fastening member. In this regard, in the vehicle lower striker structure having the above-described configuration, since the striker shaft is in contact with the base plate from above, the load acting on the striker shaft is easily transmitted to the base plate without passing through the fastening member. Therefore, the vehicle lower striker structure can reduce the load on the fastening member when the load acts on the striker shaft.

It is preferable that the vehicle lower striker structure further includes a fastening member that fixes the striker shaft to the base plate, the base plate has two bent portions extending upward on both sides in a width direction of the slit, and the striker shaft is fixed to the base plate in a state of being engaged with the two bent portions.

When the locking portion of the door lock device is locked to the striker shaft, a load including a component in the extending direction of the slit may act on the striker shaft. In this regard, in the vehicle lower striker structure having the above-described configuration, since the striker shaft is engaged with the bent portions extending upward, the load acting on the striker shaft is easily transmitted to the base plate. Therefore, the vehicle lower striker structure can reduce the load on the fastening member when the load acts on the striker shaft.

In the vehicle lower striker structure, it is preferable that the base plate includes a first portion and a second portion each having a plate shape, and a coupling portion that couples the first portion and the second portion such that the second portion is positioned above the first portion, the slit is provided in the second portion, and the striker shaft is fixed to the second portion.

In the vehicle lower striker structure, the striker shaft, which is an object to be locked by the locking portion of the door lock device, can be disposed on the upper side of the vehicle lower striker structure, and a portion of the vehicle lower striker structure, which is not an object to be locked by the locking portion of the door lock device, can be disposed on the lower side of the vehicle lower striker structure. Therefore, in the vehicle lower striker structure, the striker shaft can be disposed in the vicinity of the vehicle door positioned at a fully-closed position. Therefore, the locking portion of the door lock device can be easily locked to the striker shaft without increasing a size of the locking portion of the door lock device.

The vehicle lower striker structure can reduce a thickness in an upper-lower direction.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle lower striker structure disposed below a door opening portion opened and closed by a vehicle door, the vehicle lower striker structure comprising:
a base plate that has a plate shape whose plate thickness direction is an upper-lower direction, the base plate having a slit extending in a direction intersecting with the plate thickness direction; and
a striker shaft that has a rod shape whose longitudinal direction is a direction intersecting the upper-lower direction, the striker shaft being fixed to the base plate and straddling the slit.

2. The vehicle lower striker structure according to claim 1, wherein
the striker shaft has a rod shape extending in a straight line shape.

3. The vehicle lower striker structure according to claim 2, wherein
the striker shaft has a thickness in the upper-lower direction smaller than a width of the striker shaft in an extending direction of the slit.

4. The vehicle lower striker structure according to claim 2, wherein
a side surface of the striker shaft intersecting with an extending direction of the slit has an arc shape protruding outward when viewed from the longitudinal direction of the striker shaft.

5. The vehicle lower striker structure according to claim 2, wherein
an upper surface and a bottom surface of the striker shaft intersecting with the upper-lower direction are flat surfaces, and
the striker shaft is in contact with the base plate from above.

6. The vehicle lower striker structure according to claim 2, further comprising:
a fastening member that fixes the striker shaft to the base plate, wherein
the striker shaft is in contact with the base plate from above.

7. The vehicle lower striker structure according to claim 2, further comprising:
a fastening member that fixes the striker shaft to the base plate, wherein
the base plate has two bent portions that are bent upward on both sides in a width direction of the slit, and
the striker shaft is fixed to the base plate in a state of being engaged with the two bent portions.

8. The vehicle lower striker structure according to claim 2, wherein
the base plate includes a first portion and a second portion each having a plate shape, and a coupling portion that couples the first portion and the second portion such that the second portion is positioned above the first portion,
the slit is provided in the second portion, and
the striker shaft is fixed to the second portion.
